(19) United States
(12) Patent Application Publication
(10) Pub. No.: US 2011/0318612 A1
(43) Pub. Date: Dec. 29, 2011

(54) INDICATOR FOR DISPLAY OF BATTERY FRESHNESS

(75) Inventors: Ingo Laible, Arlesheim (CH); Stefan Probst, Weil am Rhein (DE); Christian Seiler, Auggen (DE); Werner Thoren, Steinen (DE)

(73) Assignee: Endress + Hauser Process Solutions AG, Reinach (CH)

(21) Appl. No.: 13/139,323

(22) PCT Filed: Nov. 20, 2009
(86) PCT No.: PCT/EP09/65525

§ 371 Date: Jun. 13, 2011

(30) Foreign Application Priority Data
Dec. 11, 2008 (DE) 102008054543.0

(51) Int. Cl. H01M 10/48; H01M 10/42

(52) U.S. Cl. 429/50; 429/93

(57) ABSTRACT

A battery module having at least one battery and an indicator unit, wherein the status of the indicator unit displays, whether the battery module is fresh or used, wherein an irreversible change of the indicator unit can be brought about externally, wherein through the irreversible change it is displayed that the battery module is no longer fresh, and wherein the status of the indicator unit is externally queryable.

The invention relates to a battery module as defined in the preamble of claim 1 as well as a device as defined in the preamble of claim 11. Furthermore, the invention relates to a method for following the state of a battery module, as such method is defined in claim 20.

Batteries are used for electrical current supply of many different devices. However, the power reserve of batteries is limited. When the batteries of a device are empty, proper functioning of the device is no longer assured, and the device fails.

In such case, it depends both on the type of battery operated device as well as also on the use of the device, as to what extent such battery-related failure of a device can be tolerated. There are many uses, in the case of which a sudden, battery-related device failure can lead to great harm, which is, of course, unacceptable.

For example, battery driven field devices are frequently used in process automation technology. The use of batteries avoids the need to supply such field device with electrical current via cable. Battery driven, field devices can, moreover be equipped, for example, with components for wireless data transmission, so that, also for transmission of data, no cable connection is required. Such battery driven, field devices can be installed in difficulty accessible locations of a production plant without any cable connection.

A battery-related failure of such a field device can lead, for example, to down time for a system or sub-system of process automation technology, and such down time can result in high costs. In the case of use of battery operated field devices, consequently, reliable monitoring of battery life of the field devices is necessary, in order to prevent expensive down time. The present invention is, however, not limited to battery driven, field devices.

An object of the invention is to improve monitoring of the state of a battery module.

This object is achieved by the features set forth in claims 1, 11 and 20.

Advantageous further developments of the invention are set forth in the dependent claims.

The battery module of the invention includes at least one battery as well as an indicator unit, wherein the status of the indicator unit displays whether the battery module is fresh or used. An irreversible change of the indicator unit can be brought about externally, wherein through the irreversible change it is displayed that the battery module is no longer fresh. The status of the indicator unit is externally queryable.

Before bringing about the irreversible change, the indicator unit shows that the battery module is fresh. In the case of the first insertion of the battery module into a device, during the first use, or after the first use, of the battery module, the irreversible change of the indicator unit is then brought about, in order so to designate, that the battery module no longer is fresh.

The indicator unit of the battery module of the invention shows whether the battery module is fresh or not. In this way, an externally queryable indicator is provided, which displays, whether the battery module is fresh or already used. This indicator can be queried externally, for example, via the battery operated device, which is supplied with electrical current by the battery module.

A device of the invention includes a seat for an above described battery module as well as an operating unit. The operating unit is designed to query the status of the indicator unit of the battery module. In such case, the status of the indicator unit shows whether the battery module is fresh or used. The operating unit is designed, upon first time use of the battery module, to bring about an irreversible change of the indicator unit, wherein, by the irreversible change, it is displayed that the battery module is no longer fresh.

The battery module, which is inserted into the corresponding seat of the device, includes an indicator unit, whose status displays, whether the battery module is fresh or already used. This indicator can be queried by the battery operated device, which is supplied with electrical current by the battery module.

When the query of the indicator shows that a fresh battery module is present, then the device can, for example, initialize a component for monitoring battery life, for example, a comsumption calculator, an operated hours counter, a power meter, a consumption meter, etc. With the help of this component, then the battery life can be monitored. Especially, for example, timely before the end of the battery life, replacement of the battery module can be requested.

In this way, reliable monitoring of the battery life is enabled. Through the automated monitoring of battery life, battery-related device failures can be prevented. In this way, reliability during operation of a battery operated device is improved.

In a preferred form of embodiment, a battery module of the invention with an indicator unit is used e.g. in a battery operated field device. This has the advantage that the danger of system failures as a result of a battery-related failure of a field device is reduced. In this way, reliability and cost effectiveness during operation of a process plant are increased. The application of the battery module of the invention is not limited to applications in process automation technology.

The invention will now be explained in greater detail based on examples of embodiments shown in the drawing, the figures of which show as follows:

FIG. 1 fieldbus system with a field device connected via a wireless interface;

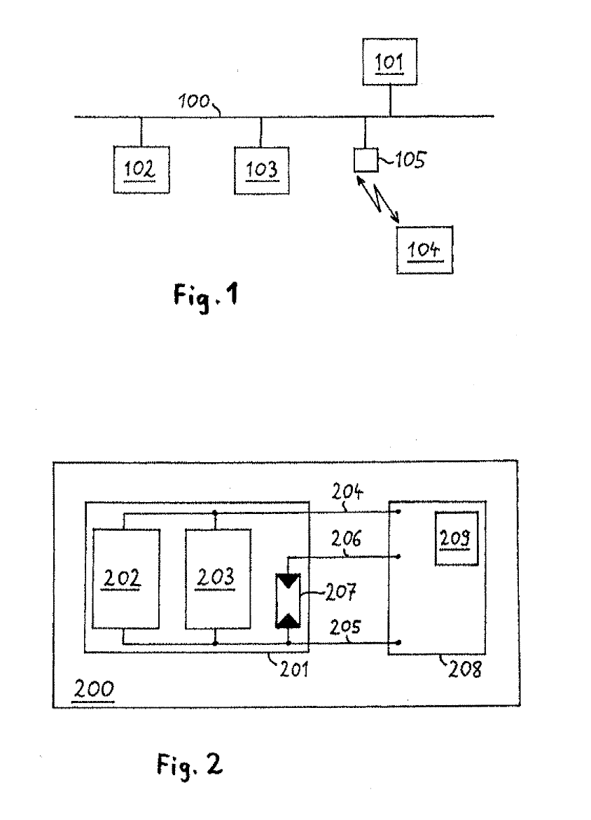

FIG. 2 device with a battery module according to a first form of embodiment of the invention;

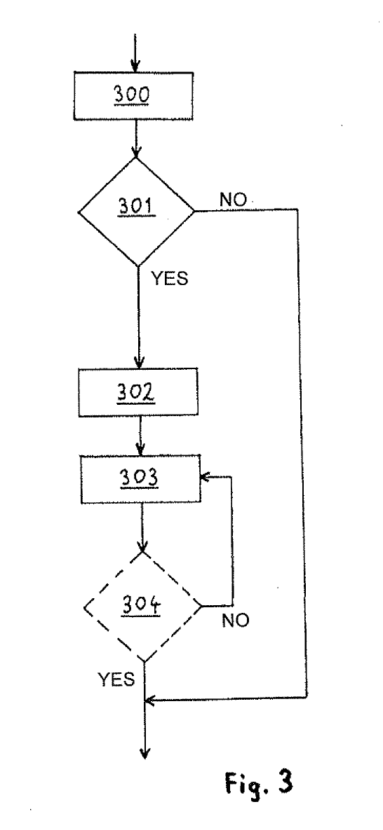

FIG. 3 flow diagram for query and modification of the battery freshness indicator;

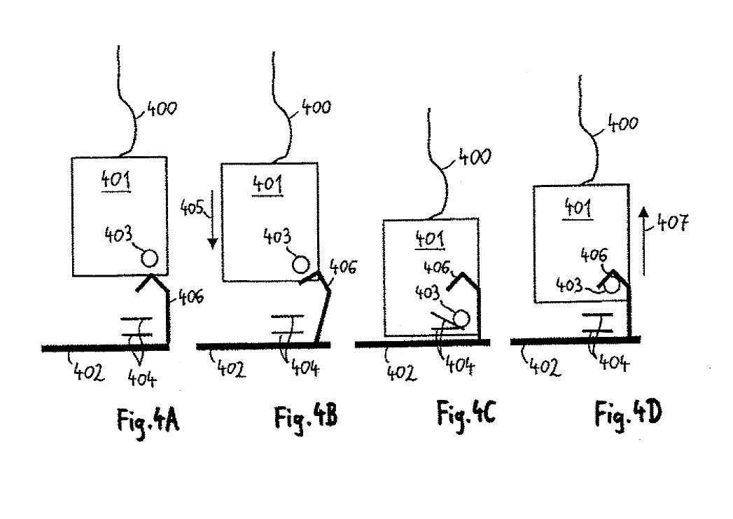

FIG. 4A-4D another form of embodiment, in which the battery freshness indicator is implemented with mechanical means;

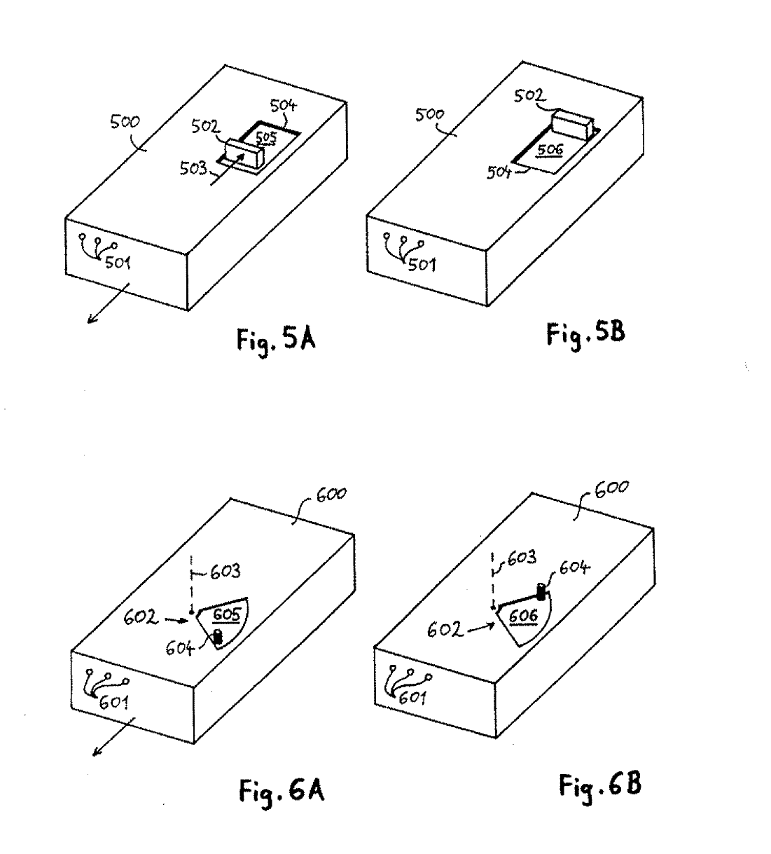

FIGS. 5A, 5B another form of embodiment, in which the battery freshness indicator is implemented by means of a push switch; and

FIGS. 6A, 6B another form of embodiment, in the case of which the battery freshness indicator is implemented by means of a rotary switch.

FIG. 1 shows a fieldbus system, which includes a fieldbus 100, a programmable logic controller 101 and three field devices 102, 103 and 104 connected to the fieldbus 100. Field device 104 is a battery operated field device, which has a communication component for wireless data exchange with a transmitting/receiving unit 105 connected to the fieldbus 100. Via such a wireless connection of the field device to the fieldbus system, installation of the field device is simplified.

In the case of battery operated field devices and communication components, it is important to replace their battery modules in a timely manner, in order to prevent sudden failure. Batteries for supplying field devices or communication components are, in the delivered condition, so packaged that the packaging must be destroyed before use. For following the battery state, for example, a comsumption calculator, an operated hours counter or a power meter of the battery operated device can be reset, upon insertion of a fresh battery module just removed from its packaging.

In the forms of embodiment of the present invention the given device queries whether it is a fresh battery module or a used battery module, in order then to be able to follow the power reserve of the battery module automatically. For this purpose, a battery module of the invention is applied with an indicator that can be read out by the respective battery operated device. The indicator displays, whether the associated battery module is fresh or not. Only when a fresh battery module with full power reserve is present, is the device-internal, power- or operated hours counter initialized.

A first form of embodiment of the invention is shown in FIG. 2. A battery operated field device 200 is supplied with electrical current by a battery module 201. The battery module 201 includes a number of batteries 202, 203, for example single use batteries, which provide the battery operated field device 200 via the two supply lines 204 and 205 with the required electrical power. Moreover, the battery module 201 is connected via a detection line 206 with the field device 200. Via the detection line 206, the field device 200 can query whether the battery module 201 is fresh or not. Serving as indicator for the freshness of the battery module 201 is a melting fuse 207, which is connected between the supply line 205 and the detection line 206.

For querying the state of the battery module 201, the field device 200 includes an evaluation unit 208, which can be implemented, for example, with the assistance of a microcontroller 209. The evaluation unit 208 determines whether a detection electrical current can flow between the supply line 205 and the detection line 206. The detection electrical current applied for querying should be relatively small (for example, in the range of microamperes), in order not to destroy the melting fuse 207.

In the case of a fresh battery module 201, the melting fuse 207 is intact and provides a conducting connection between the supply line 205 and the detection line 206. In the first querying of a fresh battery module 201, therefore, a detection electrical current can flow through the melting fuse 207.

Upon ascertaining that the battery module 201 is fresh, in a step following thereon, the melting fuse 207 is melted through by placing on the supply line 205 and the detection line 206 a correspondingly stronger, temporary electrical current pulse. For melting the melting fuse 207 through, for example, an electrical current pulse of some seconds duration with a magnitude of some milliamperes can be sufficient. The melted through melting fuse 207 indicates that a used battery module is present, i.e. one which has already been in use.

For checking whether the melting fuse 207 was successfully melted through, an additional checking step can be provided, in the case of which the melting fuse 207 is supplied, after the melting through, with a small detection electrical current via the supply line 205 and the detection line 206. If no electrical current can flow through the melting fuse 207, the melting through of the melting fuse 207 was successful.

The melting fuse 207 serves as an indicator of the freshness of the battery module. In case the evaluation unit 208, upon insertion of the battery module 201, detects an electrical current flow between the supply line 205 and the detection line 206, then the battery module 201 is a fresh battery module. The evaluation unit 208 can then, for example, initialize a comsumption calculator, an operated hours counter, a consumption meter, etc. of the field device 200.

In case the evaluation unit 208, upon insertion of the battery module 201, however, determines that no electrical current flow between the detection line 206 and the supply line 205 is possible, then the melting fuse 207 was already melted through, and it is a used battery module 201. In this case, there is in the field device 200 no resetting, or initializing, of the comsumption calculator, operating hours counter, power meter, etc.

FIG. 3 shows in the form of a flow diagram the steps performed by the evaluation unit 208 for querying and modifying the battery freshness indicator.

In a first step 300, a battery module is inserted into the relevant battery driven device.

In a following thereon, querying step 301, an indicator of battery freshness of the battery module is queried by means of a suitable detection signal, in order to ascertain whether the battery module is fresh or used. In the case of the example shown in FIG. 2, evaluation unit 208 ascertains whether electrical current flow through the melting fuse 207 is possible.

In case it is a fresh battery module, in a next step 302, a component provided in the battery operated device for tracing the battery state is initialized, or re-set. The component for following the battery state can be, for example, a comsumption calculator, an operated hours counter or a power meter. Since the particular calculator, or counter, is re-set upon insertion of a fresh battery module, the battery life of the battery module can be tracked, so that the user can be requested timely before expiration of the battery life to replace the battery module. In this way, a battery-related failure of the battery operated device can be prevented.

In the following step 303, via the evaluation unit 208, an irreversible change of the indicator of battery freshness is performed on the battery module. In this way, the battery module is marked as used. In the case of the example shown in FIG. 2, this irreversible change of the battery freshness indicator is effected by the evaluation unit 208, which applies a sufficiently large electrical current pulse to the melting fuse 207 to melt it through.

In an optional step 304 following thereon, the evaluation unit can check whether the irreversible change of the indicator in the battery module was successfully effected. Step 304 is not absolutely required and is therefore drawn dashed. In case the irreversible change was not successfully performed, then step 303 is repeated. Otherwise, the flow diagram has reached its end.

FIGS. 4A to 4D show another form of embodiment of battery freshness indicator, this one being implemented with mechanical means. As shown in FIG. 4A, a battery module is connected via a cable 400 with a plug 401, which can be introduced into a corresponding socket 402 of a battery operated field device or a communication component. Plug 401 includes a projection 403, which is provided for actuation of an arranged electrical contact 404 on the side of the socket 402.

When the plug 401 is pushed as shown in FIG. 4B in the direction of the arrow 405 into the socket 402, projection 403 presses first laterally against a catch 406. As shown in FIG. 4C, the projection 403 then closes the electrical contact 404. Through the closing of the electrical contact 404, the evaluation unit of the battery operated field device is thereby informed that a fresh battery module was introduced.

FIG. 40 shows the situation as the plug 401 of the battery module is pulled back out of the socket 402. Upon moving the plug 401 in the direction of the arrow 407, first the electrical contact 404 is opened. Then, the projection 403 is caught by the catch 406. Because projection 403 is provided with a weak point, projection 403 is broken off by the catch 406, upon additional withdrawal of the plug 401, so that plug 401, following the withdrawal, no longer has a projection for actuation of the contact. By this irreversible change of the plug 401, the battery module is marked as a used battery module.

The projection 403 serves in the case of the form of embodiment illustrated in FIGS. 4A to 4D as indicator, which displays whether the battery module is fresh or used. The particular state of the projection is queried by the field device with the assistance of the electrical contact 404. When the electrical contact 404, upon the pushing in of the plug 401, becomes closed, then it can be assumed therefrom, that the battery module is a fresh battery module. Therefore, upon the closing of the electrical contact 404, the field device can, for example, initialize or reset a comsumption calculator, an operating hours counter or a power meter. In case, in contrast, upon the pushing in of the plug 401 into the corresponding socket 402 of the field device, the electrical contact 404 is not closed, then it can be assumed therefrom, that the battery module is a used battery module. In this case, there is no initializing of the corresponding counter-, or calculator unit.

FIGS. 5A and 5B show another form of embodiment of a battery freshness indicator, which is implemented by means of a push switch. The battery module 500 includes a number of plug connectors 501, via which the battery module 500 can supply a device with electrical current. Moreover, the battery module 500 includes a push switch 502, which serves as indicator for battery freshness. If the push switch 502 is located in the first position shown in FIG. 5A, it is a fresh battery module.

The push switch 502 is designed, such that, upon first time insertion of the battery module 500 into a device, to move into the second position shown in FIG. 5B. The moving of the push switch 502 occurs, for example, from the feature that the device housing or a thereto applied lug acts in the direction of the arrow 503 on the push switch 502. When the push switch 502 is located in the second position, this shows that the battery module 500 is no longer fresh. The position of the push switch 502 serves as indicator of whether the battery module 500 is fresh or used.

The position of the push switch 502 can queried by the device and used for resetting a component provided for following the battery life. Upon the movement of the push switch 502 into its second position, for example, a comsumption calculator, a consumption meter, an operated hours counter or a power meter can be re-set.

In order that a user can see whether the battery module 500 is fresh or not, the push switch 502 can supplementally be provided with a colored marking. When the push switch 502 is located in the first position as shown in FIG. 5A, for example, a white highlighted region 505 could be visible in the viewing window 504. When the push switch 502, in contrast, is located in the second position as shown in FIG. 5B, then, for example, a red colored region 506 could be visible in the viewing window 504. In this way, the user can immediately detect whether the battery module 500 is fresh or not.

Instead of a push switch, alternatively also a rotary switch can be used as indicator of battery freshness. Such a form of embodiment is shown in FIGS. 6A and 6B. The battery module 600 includes a number of plug connectors 601 for supplying a device with electrical power. Moreover, the battery module 600 includes a rotary switch 602, which can be rotated about a rotational axis 603.

The rotary switch includes an operating lug 604. In the case of the first time insertion of the battery module 600 into a device, the device housing acts on the operating lug 604, so that the rotary switch 602 is moved into the second position shown in FIG. 6B. When the rotary switch 602 is located in the second position, this shows that it is a used battery module 600. The position of the rotary switch 602 serves as indicator of whether the battery module 600 is fresh or used.

As a function of the position of the rotary switch 602, for example, different electrical resistors can be inserted into a detection electrical current circuit. The voltage drop across these resistors then shows whether the battery module 600 is fresh or used.

In order that a user can detect whether the battery module 600 is fresh or used, the rotary switch 602 can be provided supplementally with a colored marking. In the first position of the rotary switch 602, visible in a viewing window is a first color marked segment 605, while in the second position of the rotary switch 602 a second color marked segment 606 is visible.

The rotary switch 602 can also have more than two switch positions, wherein the rotary switch, upon each pushing in of the battery module into the device, is moved to a next position.

In an additional form of embodiment of the invention, the battery freshness indicator can be implemented by means of a programmable, non-volatile memory. For example, the battery module can be equipped with an EEPROM or a flash EEPROM. In the case of this form of embodiment, a value stored in the EEPROM serves as indicator for the freshness of the battery module. Upon first time use of the battery module, at least one of the values stored in the EEPROM is reprogrammed by means of a strong voltage pulse issued by the device, in order to indicate that the battery module is no longer fresh.

1-21. (canceled)

22. A battery module having:
at least one battery; and
an indicator unit, whose status displays whether the battery module is fresh or used, wherein:
an irreversible change of said indicator unit can be brought about externally;
through the irreversible change it is displayed that the battery module is no longer fresh; and
the status of said indicator unit is externally queryable.

23. The battery module as claimed in claim 22, wherein:
the status of said indicator unit is queryable externally by means of a detection signal.

24. The battery module as claimed in claim 22, wherein:
the battery module comprises a plug; and
said indicator unit is arranged in said plug of the battery module.

25. The battery module as claimed in claim 22, wherein:
said indicator unit comprises a melting fuse, which is externally destructable by means of an electrical current- or voltage pulse.

26. The battery module as claimed in claim 25, wherein:
the battery module is connectable with a device via two supply lines and a detection line; and
said melting fuse is connected between one of said supply lines and said detection line.

27. The battery module as claimed in claim 22, wherein:
said indicator unit comprises a mechanical operating element, which is designed to actuate an electrical contact of the device; and
said mechanical operating element is designed to be broken off upon first time removal of the battery module from the device.

28. The battery module as claimed in claim 22, wherein:
said indicator unit comprises a switch, which is designed to be actuated upon first time insertion of the battery module into a device.

29. The battery module as claimed in claim 28, wherein:
said switch supplementally includes an optical marking for display of status of the indicator unit.

30. The battery module as claimed claim 22, wherein:
said indicator unit includes at least one non-volatile memory location, whose stored value is externally changeable.

31. The battery module as claimed in claim 30, wherein:
a value stored in said at least one non-volatile memory location is externally changeable by applying an electrical current-, or voltage pulse.

32. A device, comprising:
a seat for a battery module, said battery module comprising:
at least one battery; and
an indicator unit, whose status displays whether the battery module is fresh or used, wherein:
an irreversible change of said indicator unit can be brought about externally;
through the irreversible change it is displayed that the battery module is no longer fresh; and
the status of said indicator unit is externally queryable; and
an operating unit, which is designed to query the status of the indicator unit of the battery module, wherein:
the status indicates whether the battery module is fresh or used, and, upon first time use of the battery module, to bring about an irreversible change of said indicator unit; and
through the irreversible change it is displayed that the battery module is no longer fresh.

33. The device as claimed in claim 32, wherein:
said operating unit is designed to query the status of said indicator unit by means of a detection signal.

34. The device as claimed in claim 32, characterized by a component for monitoring battery life, wherein:
said operating unit is designed to initialize said component for monitoring battery life upon first time use of a fresh battery module.

35. The device as claimed in claim 34, wherein:
said component for monitoring battery life comprises: a consumption calculator, a consumption meter, an operated time counter, and a power meter.

36. The device as claimed in claim 32, wherein:
said operating unit is designed to check, after an attempt to bring about the irreversible change, whether the irreversible change was successfully brought about.

37. The device as claimed in claim 32, wherein:
said indicator unit comprises a melting fuse, and that said operating unit is designed to destroy, by means of an electrical current- or voltage pulse, said melting fuse upon first time use of the battery module.

38. The device as claimed in claim 32, wherein:
said indicator unit comprises a mechanical operating element, which is designed to actuate an electrical contact of the device; and
the device includes a catch, which is designed to break off the mechanical operating element upon first time removal of the battery module from the device.

39. The device as claimed in claim 32, wherein:
said indicator unit comprises a non-volatile memory location; and
said operating unit is designed to change a value stored in the non-volatile memory location upon first time use of the battery module by applying an electrical current- or voltage pulse.

40. The device as claimed in claim 32, wherein:
at least one of the following features exists:
the device is a field device;
the device is a field device comprising a measuring unit;
the device is a field device comprising a measuring unit as well as a communication component for wireless data exchange;
the device is a communication component.

41. The method for following state of a battery module, which comprises the steps of:
querying an indicator unit of the battery module and ascertaining whether the battery module is fresh or not; and,
if the battery module is fresh, bringing about an irreversible change of the indicator unit to indicate that the battery module is no longer fresh.

42. The method as claimed in claim 41, further comprising the step of:
if the battery module is fresh, initializing a component for monitoring battery life, especially a comsumption calculator, a consumption calculator, an operated time counter or a consumption meter.
